(19) United States
(12) Patent Application Publication
(10) Pub. No.: US 2025/0265262 A1
(43) Pub. Date: Aug. 21, 2025

(54) Method of Processing Structured Data and Storage Medium

(71) Applicant: SHIMADZU CORPORATION, Kyoto-shi (JP)

(72) Inventors: Kanako MITA, Kyoto-shi (JP); Yohei YAMADA, Kyoto-shi (JP)

(21) Appl. No.: 19/002,818

(22) Filed: Dec. 27, 2024

(30) Foreign Application Priority Data
Feb. 19, 2024 (JP) 2024-023007

(51) Int. Cl. G06F 16/248; G06F 16/483

(52) U.S. Cl. CPC G06F 16/248; G06F 16/483

(57) ABSTRACT

A method of processing structured data related to an experiment includes creating structured data by using a computer, and generating a control signal for operating an automatic experimental apparatus based on the structured data. The structured data includes a plurality of sets of items and values for conducting a predetermined experiment with the automatic experimental apparatus. The creating the structured data includes extracting, from a first information source, a first value to be input to the set, and adding a second value to a blank field of the set.

### CROSS REFERENCE TO RELATED APPLICATIONS

This non-provisional application is based on Japanese Patent Application No. 2024-023007 filed on Feb. 19, 2024 with the Japan Patent Office, the entire contents of which are hereby incorporated by reference.

### BACKGROUND OF THE INVENTION

### Field of the Invention

The present disclosure relates to a method of processing structured data and a storage medium, and more particularly, to a method of processing structured data related to an experiment and a storage medium.

### Description of the Background Art

In recent years, techniques have been developed to extract experimental condition data contained in external sources (papers and/or experimental videos), as exemplified in the following documents:
“Protocol Generation from Experimental Videos Using VideoCLIP”, Koki Yamamoto et al., Proceedings of the 29th Annual Conference of the Association for Natural Language Processing, March 2023, pp. 2306-2311;
“Automatic Extraction and Structuring of Physical Property Data of Polymer Materials from Papers and the like”, [online], [retrieved Oct. 3, 2023], Internet <URL: https://www.nature.com/articles/s41598-022-14735-4>;
Marta Skreta et al., “Errors are Useful Prompts: Instruction Guided Task Programming with Verifier-Assisted Iterative Prompting”, March 2023, https://doi.org/10.48550/arXiv.2303.14100; and
Lina Liu et al., “L-Tryptophan Production in Escherichia coli Improved by Weakening the Pta-AckA Pathway”, 27 Jun. 2016, doi:10.1371/journal.pone.0158200.

For example, “Protocol Generation from Experimental Videos Using VideoCLIP”, Koki Yamamoto et al., Proceedings of the 29th Annual Conference of the Association for Natural Language Processing, March 2023, pp. 2306-2311 discloses a technique of automatically generating an experimental protocol from experimental videos.

### SUMMARY OF THE INVENTION

However, parameters (values) of all the experimental conditions for conducting an experiment may not be disclosed in papers and experimental videos, and common values in the field of the experiment may not be disclosed in many cases. On the other hand, when an experiment is conducted automatically by using an automatic experimental apparatus, it is necessary to set values (including values which are not disclosed) of all the experimental conditions. Therefore, even if the values of the experimental conditions are extracted from predetermined papers or predetermined experimental videos, the extracted values alone may not be sufficient to conduct an automatic experiment by using an automatic experiment apparatus.

An object of the present invention is to conduct an experiment by using an automatic experimental apparatus based on structured data created by extracting experimental condition data from an external source.

According to a first aspect of the present invention, there is provided a method of processing structured data related to an experiment, the method includes: creating the structured data by using a computer; and generating a control signal for operating an automatic experimental apparatus based on the structured data. The structured data includes a plurality of sets of items and values for conducting a predetermined experiment with the automatic experimental apparatus. The creating the structured data includes: extracting, from a first information source, a first value to be input into the set; and adding a second value to a blank field of the set.

According to a second aspect of the present invention, there is provided a method of processing structured data related to an experiment, the method includes: creating the structured data by using a computer; and displaying the structured data. The structured data includes a plurality of sets of items and values for conducting a predetermined experiment. The creating the structured data includes: extracting, from a first information source, a first value to be input into the set; and adding a second value to a blank field of the set.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically illustrating an example overall configuration of an experimental system;

FIG. 2 is a diagram for explaining a method of creating experimental conditions according to an embodiment;

FIG. 3 is a flowchart illustrating a procedure of processing structured data according to an embodiment;

FIG. 4 is a diagram illustrating an example of first structured data;

FIG. 5 is a diagram illustrating an example of second structured data;

FIG. 6 is a diagram illustrating an example of embed data;

FIG. 7 is a diagram illustrating an example of priority levels of experimental conditions;

FIG. 8 is a flowchart illustrating a procedure of processing structured data according to a first modification;

FIG. 9 is a flowchart illustrating a procedure of processing structured data according to a second modification;

FIG. 10 is a diagram illustrating an example of a strain information table;

FIG. 11 is a diagram illustrating an example of an experimental condition table;

FIG. 12 is a diagram illustrating an example of an experimental result table; and

FIG. 13 is a flowchart illustrating a procedure of processing structured data according to a third modification.

### DESCRIPTION OF THE PREFERRED EMBODIMENTS

Hereinafter, embodiments of the present disclosure will be described in detail with reference to the drawings. In the drawings, the same or corresponding parts are denoted by the same reference numerals, and the description thereof will not be repeated.

### 1. Configuration of an Experimental System

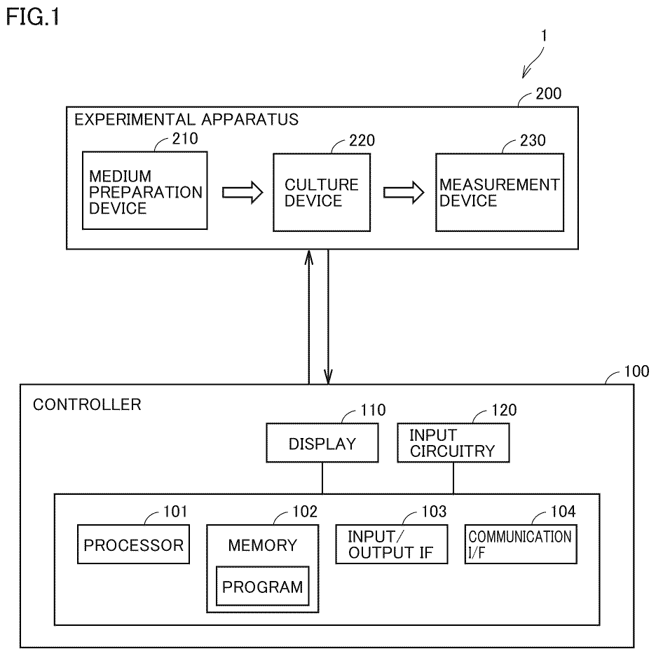

FIG. 1 is a diagram schematically illustrating an example overall configuration of an experimental system 1 according to the present embodiment. The experimental system 1 includes a controller 100 and an experimental apparatus 200.

The experimental apparatus 200 is an automatic experimental apparatus that receives a control signal from the controller 100 and automatically conducts a scientific experiment in accordance with the control signal. FIG. 1 illustrates that the experimental apparatus 200 conducts a cell culture experiment as an example experiment.

The cells to be cultured in the experimental apparatus 200 are not particularly limited, and may be, for example, cells that may be favorably used in medicine or the like, or cells that produce substances that may be favorably used in various industrial fields. In one embodiment, the cells are bacteria. In other embodiments, the cells may be microorganisms other than bacteria and/or cells derived from animals and plants other than microorganisms. The experiment conducted by the experimental apparatus 200 may be an experiment (such as a synthetic chemistry experiment) other than a cell culture experiment.

The experimental apparatus 200 includes a medium preparation device (circuitry) 210 and a culture device (circuitry) 220.

The medium preparation device 210 prepares a medium under predetermined experimental conditions in accordance with a control signal received from the controller 100. More specifically, the medium preparation device 210 accommodates a predetermined medium in a predetermined vessel and adds a strain to the predetermined medium in accordance with the control signal.

The culture device 220 cultures the strain under predetermined experimental conditions in accordance with the control signal received from the controller 100. More specifically, the culture device 220 cultures the strain at a predetermined temperature for a predetermined time in accordance with the control signal.

Preferably, the experimental apparatus 200 also includes a measurement device (circuitry) 230. The measurement device 230 measures a result of the cell culture experiment conducted by the culture device 220. The measurement device 230 transmits the experimental result to the controller 100.

The controller 100 is composed of, for example, one or more general-purpose computers. In the example of FIG. 1, the controller 100 includes a processor 101, a memory 102, an input/output interface (I/F) 103, and a communication I/F 104.

The processor 101 executes various programs to allow the controller 100 to perform various processes. The memory 102 stores programs to be executed by the processor 101 and various data required to execute the programs. The memory 102 stores programs to be executed by a computer to implement a method of processing structured data according to an embodiment. The input/output I/F 103 is an interface that allows the processor 101 to communicate with the experimental apparatus 200. The communication I/F 104 is an interface that allows the processor 101 to communicate with any external device of the experimental system 1 through a network.

The controller 100 further includes a display 110 and an input circuitry 120. The display 110 displays an arithmetic processing result of the processor 101. The input circuitry 120 (such as a mouse, a keyboard, a touch sensor, or the like) receives operations of inputting data to the processor 101.

### 2. Comparison With a Conventional Method of Creating Experimental Conditions From Papers, Experimental Videos, and the Like

Conventionally, techniques have been developed to extract experimental condition data from papers, experimental videos or the like. “Protocol Generation from Experimental Videos Using VideoCLIP”, Koki Yamamoto et al., Proceedings of the 29th Annual Conference of the Association for Natural Language Processing, March 2023, pp. 2306-2311 discloses a technique of estimating a name of an object and a motion of an experimenter from experimental videos and automatically generating an experiment protocol. “Automatic Extraction and Structuring of Physical Property Data of Polymer Materials from Papers and the like”, [online], [retrieved Oct. 3, 2023], Internet <URL: https://www.nature.com/articles/s41598-022-14735-4> discloses a technique of generating an experimental protocol from natural languages and correcting the experimental protocol by feeding back errors to a large-scale language model. Marta Skreta et al., “Errors are Useful Prompts: Instruction Guided Task Programming with Verifier-Assisted Iterative Prompting”, March 2023, https://doi.org/10.48550/arXiv.2303.14100, describes a technique of extracting physical property data of a material from papers or the like and creating structured data.

However, in many cases, parameters (values) of all the experimental conditions for conducting a predetermined experiment are not disclosed in papers and experimental videos. On the other hand, in an automatic experimental apparatus, it is necessary to input values of all the experimental conditions. Therefore, even if the values of the experimental conditions are extracted from predetermined papers or predetermined experimental videos, the extracted values alone may not be sufficient to conduct an automatic experiment using an automatic experiment apparatus.

In view of the above problems, in the method of processing structured data according to the present embodiment, appropriate values are added to experimental conditions that are not disclosed in papers, experimental videos, and the like. Thus, an experiment, which is disclosed in papers, experimental videos, and the like, and in which the values of all experimental conditions are not disclosed, can be conducted in an automatic experimental apparatus.

### 3. Method of Creating Experimental Conditions According to an Embodiment

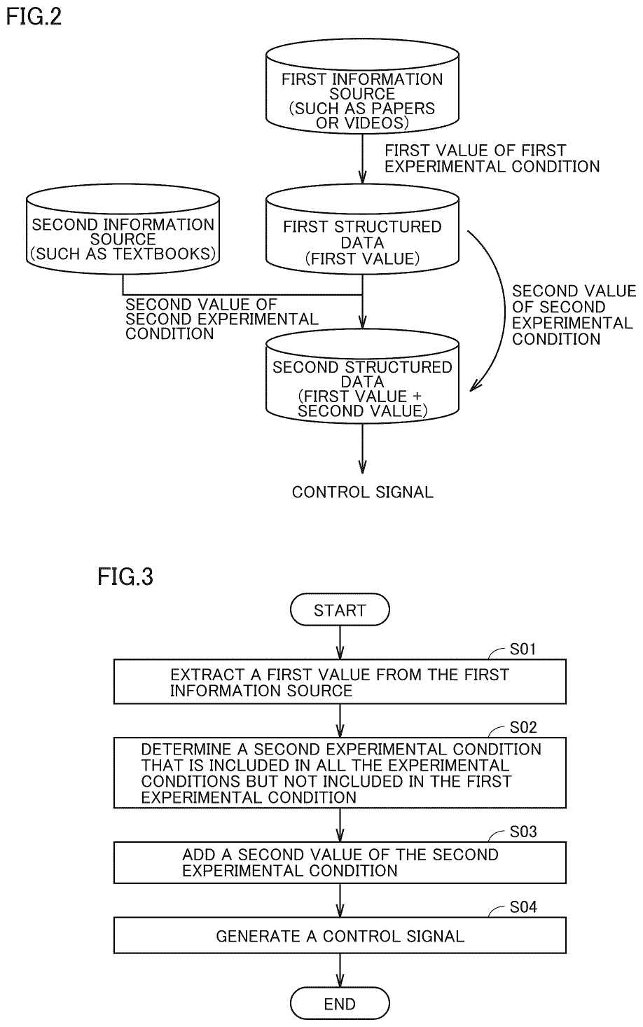

FIG. 2 is a diagram for explaining a method of creating experimental conditions according to an embodiment.

With reference to FIG. 2, a first information source refers to an information source that discloses values of experimental conditions for one or more predetermined experiments. The first information source may be, for example, an information source that discloses experiments conducted for a predetermined purpose and/or for a predetermined experimental result. The first information source preferably includes papers and/or experimental videos. With such a configuration, since papers and/or experimental videos related to a predetermined experiment often disclose a predetermined experimental result and/or the purpose of a predetermined experiment, the user may refer to the experimental result and/or the purpose disclosed in the papers and/or experimental videos to decide to conduct the predetermined experiment (which will be described later in detail).

As an example, the first information source corresponds to an external source. In one embodiment, the controller 100 accesses an external paper database and/or a homepage on which experimental videos are collected via the communication I/F 104 to collect the first information source. Then, the controller 100 extracts values of the experimental conditions from the first information source. In the present specification, the first information source includes at least values of the experimental conditions, and may include values of strain information and/or values of experimental results. As an example, the experimental conditions correspond to items. In other embodiments, the items may correspond to strain information and/or experimental results.

In the present specification, a value of an experimental condition extracted from the first information source for a predetermined experiment is referred to as a “first value”. In the present specification, as an example, the first value of the experimental condition corresponds to “a first value to be input into the set”. The experimental condition under which the first value can be extracted is referred to as a “first experimental condition”. In other words, the first experimental condition is an experimental condition under which a corresponding value can be extracted for a predetermined experiment. For example, when a value “LB medium” of an experimental condition “medium” is extracted from a first information source for a predetermined experiment, the controller 100 determines that the “medium” is the first experimental condition and the “LB medium” is the first value. In the present specification, the relationship between a predetermined item (medium) and a predetermined value (LB medium) as described above is referred to as the “correspondence” between the predetermined item and the predetermined value. In addition, a predetermined value corresponding to the predetermined item is also simply referred to as a “value of the predetermined item”.

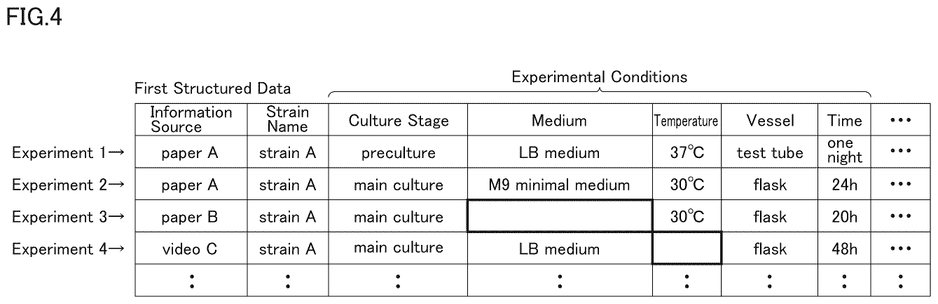

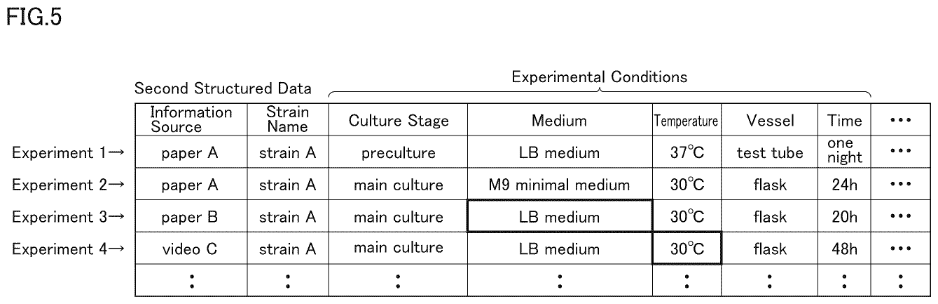

In one embodiment, the controller 100 stores the extracted first value as first structured data (see FIG. 4 to be described below). The first structured data includes a plurality of sets including items and values for conducting a predetermined experiment, and the same applies to second structured data (see FIG. 5 to be described below). In the tables of FIGS. 4 and 5, each column corresponds to each set that includes items (in the first row from the top) and one or more values (in the second and subsequent rows).

However, as described above, in many cases, values of all the experimental conditions for conducting a predetermined experiment are not disclosed in the first information source such as papers or experimental videos. Therefore, even if the first values of the first experimental condition disclosed in the first information source are extracted, the values may not be sufficient for all the experimental conditions. In this case, a blank field is left in the first structured data.

For example, in the first structured data of FIG. 4, the value of “medium” cannot be extracted for Experiment 3 and is left blank. In the experimental video C, the value of “temperature” cannot be extracted for Experiment 4 and is left blank.

In the present specification, an experimental condition that is included in all the experimental conditions for conducting a predetermined experiment but not included in the first experimental condition is referred to as a “second experimental condition”. In other words, the second experimental condition is an experimental condition having a value that is included in the values of all the experimental conditions for conducting a predetermined experiment disclosed in the first information source but cannot be extracted from the predetermined first information source. The second experimental condition is basically an experimental condition, the corresponding value of which is not disclosed in the first information source, and however, any experimental condition, the corresponding value of which is disclosed in the first information source but cannot be extracted from the first information source for some reason, is also determined as the second experimental condition.

As described above, in the automatic experimental apparatus, it is necessary to input values of all the experimental conditions for conducting a predetermined experiment. Therefore, the controller 100 adds an appropriate value (a second value) as a corresponding value that could not be extracted for the second experimental condition.

In one embodiment, the controller 100 adds the second value by using a second information source. In this embodiment, the second information source is an information source that includes experimental conditions common to those skilled in the art. The second information source includes, for example, a textbook.

In another embodiment, the controller 100 adds the second value by using the first structured data.

In the present specification, the structured data obtained by adding the second value to the first structured data is referred to as “second structured data” (see FIG. 5 to be described later). In the present specification, the second structured data corresponds to the “structured data” created by using a computer. For example, “LB medium” is added as the second value of “medium” for Experiment 3. Further, “30° C.” is added as the second value of “temperature” for Experiment 4.

The controller 100 converts the first value and the second value for a predetermined experiment into a control signal to be executed by the automatic experimental apparatus, and transmits the control signal to the experimental apparatus 200. The first value and the second value are values of all the experimental conditions for conducting a predetermined experiment. Therefore, the experimental apparatus 200 can conduct the predetermined experiment.

### 4. Procedure of Processing Structured Data According to an Embodiment

FIG. 3 is a flowchart illustrating a procedure of processing structured data according to the embodiment.

In steps (hereinafter also referred to as “S”) 01 to 03 of FIG. 3, the controller 100 creates structured data.

First, in S01, the controller 100 extracts, from a first information source, a first value to be input to the set. In one embodiment, the controller 100 extracts a first value of a first experimental condition for conducting one or more predetermined experiments. Preferably, the controller 100 is configured to extract all the experimental conditions disclosed in the first information source for each experiment described in the first information source. According to this configuration, the experimental conditions disclosed in the first information source can be maximally extracted. Preferably, the controller 100 extracts, as the first value, the value of the strain information and/or the value of the experimental result in addition to the value of the experimental condition. With this configuration, the value of the strain information and/or the value of the experimental result can be used when the user selects an experiment to be conducted in the experimental system 1 (which will be described in detail later).

The greater the number of first information sources used to extract the first value in S01 is, the more the first value can be preferably extracted and used for a large number of experiments.

In one embodiment, the controller 100 collects and utilizes the first information source, for example, as follows. First, the controller 100 downloads papers of a desired field from a paper database such as PubMed, and/or downloads experimental videos of a desired field from a website where experimental videos are collected. Then, the controller 100 collectively stores the downloaded papers and/or experimental videos and creates a first information source database including a large number of first information sources. The first information source database may be stored in the memory 102 or may be stored in a storage device that the controller 100 can communicate with via the communication I/F 104. The controller 100 retrieves the contents of each first information source from the first information source database, and extracts a first value for a predetermined experiment disclosed in the first information source.

When the first information source is a paper, the controller 100 automatically (without any user operation) extracts the first value using a method such as named entity expression extraction, a rule base, or a large-scale language model.

The named entity extraction is a technique of mechanically extracting named entities, for example, proper nouns such as product names attached with dates, quantities and the like from natural text.

The rule base is a technique of extracting data based on whether or not the data satisfies a certain rule considered by a human.

The large-scale language model is a computer language model composed of an artificial neural network with a large number of parameters.

The user may use the controller 100 to manually extract the first value from a paper. For example, the user may use the controller 100 to extract the first value by displaying a paper on the display 110 and using the input circuitry 120 to select a value (for example, a predetermined character string) for the first experimental condition and store the value. However, it is advantageous to use the controller 100 to automatically extract the first value, which may reduce the extraction time and improve the extraction accuracy. On the other hand, even if some values of the experimental conditions cannot be extracted automatically because of spelling errors or the like, they can be extracted manually.

When the first information source is an experimental video, the controller 100 automatically (without any user operation) extracts the first value using a method such as object detection or motion detection.

The object detection is a technique of extracting a name of an object included in an experimental video.

The motion detection is a technique of detecting a motion of an experimenter included in an experimental video.

In addition, the controller 100 may extract the first value from an experimental video by using a technology such as a voice recognition technology or a character string recognition technology in the experimental video.

The user may use the controller 100 to manually extract the first value from an experimental video. For example, the user may use the controller 100 to extract the first value by displaying the experimental video on the display 110 and using the input circuitry 120 to input a character string corresponding to the first value recognized from the experimental video and store the character string. However, it is advantageous to use the controller 100 to automatically extract the first value, which may reduce the extraction time and improve the extraction accuracy. On the other hand, even if the first value cannot be automatically recognized because a part of an object in the experimental video, a part of the motion of an experimenter or the like is hidden, the first value can still be visually recognized and extracted.

The controller 100 may use the methods of extracting experimental conditions from a plurality of papers or experimental videos individually or collectively.

The controller 100 may store each of the extracted first values in a format that shows the first condition corresponding to each of the extracted first values. In one embodiment, in S02, the controller 100 generates first structured data including the first value extracted from the first information source. More specifically, the first structured data is data in which the first value is structured. The first structured data may also include a value of strain information and/or a value of an experimental result along with the first value.

FIG. 4 is a diagram illustrating an example of first structured data. FIG. 4 illustrates first structured data extracted from the first information source for experiments 1-4.

In the first structured data, the value of “information source”, the value of “strain name”, and the value of “experimental condition” are associated with each other for a predetermined experiment.

In the example of FIG. 4, each row corresponds to each experiment. Each experiment is defined by the “information source” and the “strain name”. In FIG. 4, for convenience of explanation, each experiment is attached with a sequence number on the left side of the table, but each experiment is not necessarily attached with a sequence number in the first structured data.

In the example of FIG. 4, the first structured data includes items of “information source” and “strain name” and a “first experimental condition”. The first experimental condition includes items of “medium”, “temperature”, “vessel”, and “time”. For a predetermined experiment, the value of “information source”, the value of “strain name”, and the value of each experimental condition are listed in the same row. In the example of FIG. 4, the value of “information source”, the value of “culture stage”, the value of “strain name”, and the values of “experimental condition” for each of Experiments 1 to 4 are listed in each column.

In FIG. 4, the “information source” refers to a paper and/or an experimental video in which a predetermined experiment is disclosed. The value of “information source” is, for example, a title, an author name, a publication date, a digital object identifier (DOI), or the like.

The “strain name” refers to a strain to be tested in a predetermined experiment. The value of “strain name” is the name of a strain. As specific examples of the strain name, the values of “strains” in Table 1 of Lina Liu et al., “L-Tryptophan Production in Escherichia coli Improved by Weakening the Pta-AckA Pathway”, 27 Jun. 2017, doi: 10.1371/journal.pone.0158200 are incorporated by reference. The strain name may include a part of gene modification information such as a plasmid name inserted into the strain. For example, the value of “strain name” may include a character string such as FB-04, B. subtilis ATCC 6051a, E. coli CCTCC M 2016009, BL (DE3), BL21 (DE3)/pET24a-pta, BL21 (DE3)/pET24a-pta1, FB-04 (Δpta), FB-04 (ΔackA), or FB-04 (pta1).

The “medium” refers to a medium used for culturing a strain. The “temperature” refers to a temperature for culturing the strain.

The “vessel” refers to a vessel used for culturing a strain. The “time” refers to a time for culturing the strain.

Examples of experimental conditions are not limited to the above, and may include, for example, “medium amount”, “dissolved oxygen concentration”, “environment”, and/or “culture stage”.

The “medium amount” refers to an amount of medium used for culturing a strain. The “dissolved oxygen concentration” refers to a concentration of oxygen dissolved in the medium used for culturing the strain.

The “environment” indicates whether the culture environment of the strain is an aerobic environment or an anaerobic environment.

The “culture stage” indicates whether the culture of the strain is a main culture or a pre-culture which is a preparation stage of the main culture.

In the structured data of FIG. 4, the first values of a predetermined first experimental condition extracted from the first information source for a predetermined experiment are filled in cells corresponding to the predetermined experiment and the predetermined first experimental condition. On the other hand, a cell corresponding to a predetermined second experimental condition which is not extracted from the first information source for the predetermined experiment is left blank.

Specifically, in Experiment 3 of the structured data of FIG. 4, the first experimental condition includes the “culture stage”, the “temperature”, the “vessel”, and the “time”, each of which is filled with a first value, and the second experimental condition includes the “medium” which is blank.

In S02 to S03, the controller 100 adds a second value to a blank field of the set.

In S02, the controller 100 determines a second experimental condition that is included in all the experimental conditions for conducting a predetermined experiment but not included in the first experimental condition. In one embodiment, the controller 100 subtracts the first experimental condition from all the experimental conditions and sets the remaining conditions as the second experimental condition.

In S03, the controller 100 adds the second value of the second experimental condition. Hereinafter, an example of adding the second value by using the second information source and an example of adding the second value by using the first information source will be described in this order.

In a first embodiment, in S03, the controller 100 adds the second value by using the second information source for a predetermined experiment in which a part of all the experimental conditions cannot be extracted. More specifically, the controller 100 selects a similar experiment of a predetermined experiment from experiments included in the second information source. Then, the controller 100 extracts a value of the second experimental condition for conducting the similar experiment, and sets the second value based on the extracted value.

In one embodiment, the controller 100 extracts experimental conditions from a plurality of second information sources in advance and collectively stores the experimental conditions to create a second information source database including the plurality of second information sources. Then, the controller 100 searches the second information source database for the similar experiment. Then, the controller 100 extracts a value of the second experimental condition for the similar experiment.

More precisely, a similar experiment of a predetermined experiment is such an experiment that is determined to be similar to the predetermined experiment by the controller 100. One example of a similar experiment is an experiment in which the value of the strain name matches that of the predetermined experiment. Another example of a similar experiment is an experiment in which the values of one or more first experimental conditions are the same as or similar to those of the predetermined experiment. More specifically, an example of a similar experiment of Experiment 3 is an experiment in which the value of the strain name is the same as that of the predetermined experiment. Another example of a similar experiment of Experiment 3 is an experiment in which the value of the strain name is the same as that of the predetermined experiment and at least one value of the temperature, the vessel and/or the time is the same as or similar to that of the predetermined experiment.

When there is one similar experiment similar to a predetermined experiment in which a part of the values of all the experimental conditions cannot be extracted, the controller 100 sets the value of the second experimental condition of the similar experiment as the second value of the predetermined experiment. When there are a plurality of similar experiments similar to the predetermined experiment and thereby a plurality of values of the second experimental condition can be obtained, the controller 100 may randomly set one value of the plurality of values as the second value, or may set a value (a mode value) that most frequently appears in the plurality of values as the second value. As described above, the controller 100 adds an appropriate value as the second value of the second experimental condition that could not be extracted from the predetermined experiment by using the value of the experimental condition of the similar experiment.

According to the first embodiment mentioned above, the values of common experimental conditions which are likely to be omitted in papers and/or experimental videos can be easily added by using a textbook in which the common experimental conditions are disclosed. Generally, textbooks are more likely to contain orthodox but valid experimental conditions because more people are involved in the preparation of textbooks than individually prepared papers and experimental videos. Therefore, the value added by using a textbook has the advantage of being less likely to be irrelevant.

In a second embodiment, in S03, the controller 100 adds the second value by using the first information source for a predetermined experiment in which a part of all the experimental conditions cannot be extracted. More specifically, the controller 100 selects a similar experiment of a predetermined experiment from experiments included in the first information source. Then, the controller 100 extracts a value of the second experimental condition for conducting the similar experiment, and sets the second value based on the extracted value. The method of extracting the value of the second experimental condition for conducting the similar experiment and setting the second value based on the value in the present embodiment is the same as that of the first embodiment.

In one embodiment, the controller 100 searches for a similar experiment using first information structured data obtained by structuring the first value extracted from the first information source, and extracts the value of the second experimental condition of the similar experiment.

For example, in the examples of FIGS. 4 and 5, the controller 100 determines that Experiments 1, 2 and 4 using the same strain A are the similar experiments of Experiment 3. Then, since “LB medium” is the most frequently used medium in the similar experiments 1, 2 and 4, “LB medium” is added as the second value for the medium of the experiment 3. Similarly, the controller 100 adds a temperature “30° C.”, which is the most commonly used temperature in the similar experiments 1, 2 and 3, as the second value for the temperature of Experiment 4.

According to the second embodiment, the second value can be added by using the first information source collected for extracting the first value. Thus, it is possible to save the time and effort to collect a new information source for adding the second value. The similar experiment of a predetermined experiment in the first information source may be another experiment in the first information source, or may be an experiment in another first information source.

Generally, the number of papers and experimental videos is larger than that of textbooks, and it is easier to collect than textbooks. Therefore, it is considered that collecting a large number of experiments included in papers and experimental videos is easier than collecting the same number of experiments from textbooks. Thus, the second value can be added based on a large number of experiments.

In adding the second value, instead of automatically determining one second value (without any user operation), the controller 100 may display a plurality of candidates for the second value and select a second value to be added from the plurality of candidates. The candidate of a second value may be, for example, the value of the second condition of the similar experiment described above. As a more specific example, the controller 100 displays the table of FIG. 4 on the display 110, and displays a plurality of candidates for the second value to be input to a blank field near the blank field. The user uses the input circuitry 120 to select one value from the plurality of candidates, and the controller 100 inputs the selected value as the second value into the blank field. According to this configuration, the user can select an appropriate value from a plurality of candidates of the second value by himself/herself. On the other hand, the method of automatically determining the second value has an advantage of saving the time and effort of the user.

In S04, the controller 100 generates a control signal for operating an automatic experimental apparatus based on the structured data. In one embodiment, the controller 100 generates a control signal for conducting a predetermined experiment with the automatic experimental apparatus based on the first value and the second value, and ends the procedure. In other words, the controller 100 converts the values of all the experimental conditions into a control signal. Thus, the predetermined experiment can be conducted by the automatic experimental apparatus.

As described above, according to the method of processing structured data according to the embodiment, it is possible to add a value that is included in the values of all the experimental conditions for conducting a predetermined experiment disclosed in the first information source but cannot be extracted from the first information source without any operation of a user. Therefore, it is possible to conduct the predetermined experiment disclosed in the first information source. As described above, it is also possible to use an automatic analyzer to conduct an experiment in which the values of all the experimental conditions are not disclosed in the first information source such as papers and experimental videos. In other words, it is possible to use an automatic experimental apparatus to conduct an experiment by using the structured data created by extracting experimental condition data from an external source.

Thus, the user can reproduce a predetermined experiment only by selecting the predetermined experiment and/or the first information source in which the predetermined experiment is disclosed. Therefore, the user does not have to retrieve the experimental conditions from the first information source by himself/herself to add the second value.

As one use example of the controller 100 according to the embodiment, a case where a user selects an experiment to be conducted in an automatic experimental apparatus will be described. First, the user searches for a first information source that includes a desired experiment (for example, an experiment conducted for a desired purpose and/or a desired result). If the user has the first information source in mind, the user uses the input circuitry 120 to input information (for example, title, author name, publication date, DOI (Digital Object Identifier), or the like) of the first information source. If the user does not have the first information source in mind, the user may by search the second structured data (FIG. 5) stored in the memory 102 to select the first information source. After the user inputs the information of the first information source including the desired experiment, the processor 101 reads experimental conditions corresponding to the first information source specified by the user from the second structured data in the memory 102. Then, the processor 101 converts the experimental conditions into a control signal and transmits the control signal to the experimental apparatus 200 to conduct the desired experiment.

As another use example of the controller 100 according to the embodiment, a case where a user searches for experimental conditions will be described. For example, assume that a user wishes to know an appropriate culture time for culturing E. coli in a flask. In this case, the user uses the input circuitry 120 to search the second structured data (FIG. 5) stored in the memory 102 for a culture time for culturing E. coli in the flask. As a more specific example, the processor 101 may cause the display 110 to display a user interface for searching the second structured data. Then, the user uses the user interface to give an instruction to display the values of the culture time in experiments using “E. coli” and “flask”. Then, the processor 101 extracts the values of the culture time from the second structured data in the memory 102, and displays the extracted values on the display 110. Therefore, the user can save the time and effort in searching for papers describing a culture experiment in which E. coli is cultured in a flask by himself or herself in a literature database or the like and searching for the values of the culture time from the literature.

### 5. First Modification

Generally, a paper includes text data and embed data embedded in the text data. The embed data is, for example, a diagram or a table. In a paper, values of experimental conditions are mainly described in text data. However, at least a part of the values of the experimental conditions may be disclosed only in the embed data. In such a case, in order to extract all the values of the experimental conditions from the paper, it is necessary to extract the values of the experimental conditions from the embed data. However, when a computer is used to extract the values of the experimental conditions, it takes more time to extract the values of the experimental conditions from the embed data than to extract the values of the experimental conditions from the text data.

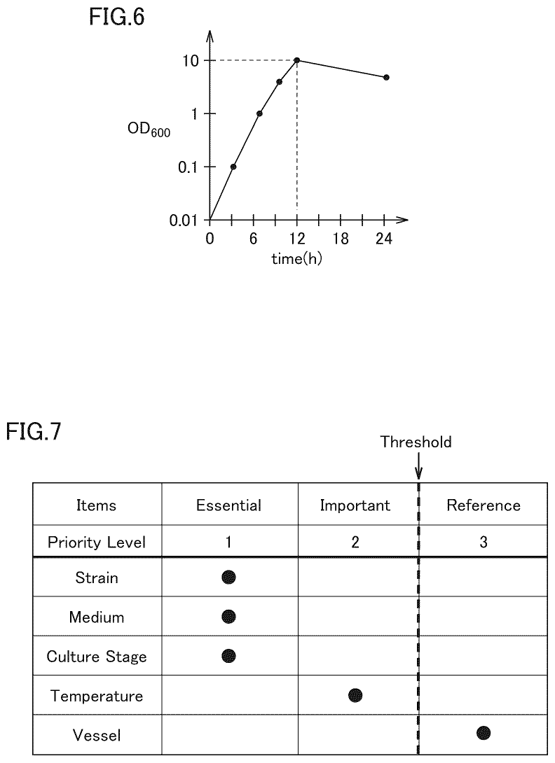

FIG. 6 is a diagram illustrating an example of embed data. FIG. 6 is a graph illustrating a relationship between a culture time and a culture result, in which the horizontal axis represents the culture time, and the vertical axis represents the culture result (concentration). As illustrated in FIG. 6, in the case of using a computer to extract the values of the culture time, for example, it is necessary to acquire the items of the horizontal axis, the positions of data points, and the values of the horizontal axis corresponding to the positions of the data points. This is generally more time consuming than using a computer to extract the values of the culture time from the text data.

In summary, in S01 of FIG. 3, when the controller 100 extracts the values of the experimental conditions only from the text data, the necessary values may not be extracted. On the other hand, when the controller 100 extracts the values of the experimental conditions from all the embed data, it requires a long time to extract the values.

Therefore, in the data processing method according to the first modification, whether or not to extract the embed data is determined according to the importance of the experimental conditions.

In the controller according to the first modification, each item (each experimental condition) is set with a priority level in advance. In one embodiment, the controller stores a table as illustrated in FIG. 7. FIG. 7 is a diagram illustrating an example of priority levels of experimental conditions.

In the experimental conditions, conditions essential for conducting an experiment have a higher priority level. For example, the “strain” indicates a strain to be cultured and is essential for conducting an experiment. The optimum composition of the “medium” is mainly dependent on the strain. Further, it is necessary to select the “culture stage” according to the purpose of conducting an experiment. Therefore, in the example of FIG. 7, the “strain”, the “medium”, and the “culture stage” are set as essential conditions with the highest priority level of 1.

In addition, some of the experimental conditions are not essential but important. For example, the value of the “temperature” may be inferred even if it is not disclosed, but it may be different for different experiments. Therefore, in the example of FIG. 7, the “temperature” is set as an important condition with a priority level of 2.

On the other hand, some of the experimental conditions are not important and for reference only. For example, the “vessel” may have no significant difference between culturing in a flask and culturing in a test tube. In addition, the “vessel” can be inferred from the purpose of an experiment and/or the amount of culture medium, and the option for the “vessel” may be omitted depending on the experiment environment. Therefore, in the example of FIG. 7, the “vessel” is set as a reference condition with the lowest priority level of 3.

As described above, the priority level is set appropriately to reflect necessary factors such as the degree of influence on experimental result and the ease of supplementation with general knowledge from textbooks and the other sources. In the example of FIG. 7, the threshold of priority level is set between 2 and 3 to determine whether or not to extract values from the embed data.

The priority levels may be set as values with an increment of “1” from 1 in the order of importance as described above. The priority levels may be set as discrete values (such as 1, 10, 100, or the like). In addition, keywords such as “essential”, “important”, and “reference” may be set as the order of priority levels, and a threshold may be set between “important” and “reference”.

As described above, in the first modification, all the experimental conditions of a predetermined experiment include an experimental condition having a priority level higher than a predetermined threshold in the predetermined experiment and an experimental condition having a priority level lower than the predetermined threshold in the predetermined experiment. Next, a method of processing structured data related to an experiment using the threshold of priority level will be described.

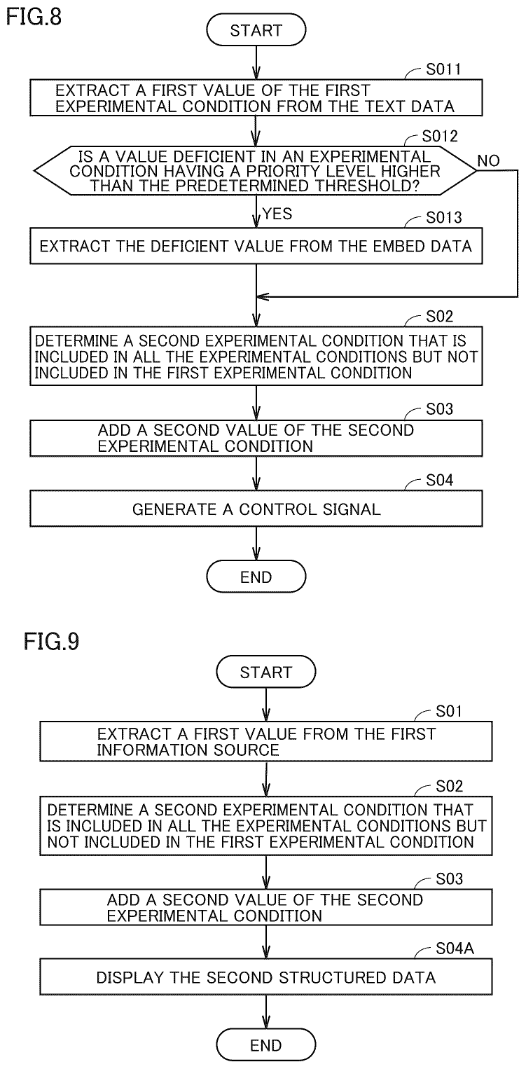

FIG. 8 is a flowchart illustrating a procedure of processing structured data according to the first modification. In the first modification, S01 in the embodiment (FIG. 3) is replaced by S011 to S013.

In step S011, the controller 100 extracts a first value of the first experimental condition from the text data of the first information source.

In S012, the controller 100 determines whether or not a value is deficient in an experimental condition having a priority level higher than a predetermined threshold after the first value is extracted from the text data.

If no value is deficient in the experimental condition having a priority level higher than the predetermined threshold (NO in S012), the controller 100 proceeds to S02.

If a value is deficient in the experimental condition having a priority level higher than the predetermined threshold (YES in S012), the controller 100 extracts the deficient value from the embed data in S013, and proceeds to S02.

According to the method of processing structured data according to the first modification, if the values of the experimental conditions extracted from the text data only is sufficient for the experimental conditions having a high priority level, the extraction process can be ended without spending time on extracting the values of the experimental conditions from the embed data. On the other hand, if the values of the experimental conditions extracted from the text data only is insufficient for the experimental conditions having a high priority level, the values of the experimental conditions are also extracted from the embed data. More specifically, the values of the experimental conditions are only extracted from the embed data in the first information source when the first information source includes experiments in which the values of the experimental conditions having a priority level higher than the predetermined threshold are insufficient. As described above, according to the method of processing structured data according to the first modification, it is possible to obtain the values of important experimental conditions in a minimum necessary time. More specifically, the second structured data can be created more efficiently.

### 6. Second Modification

FIG. 9 is a flowchart illustrating a procedure of processing structured data according to a second modification. In the second modification, S04 in the embodiment (FIG. 3) is replaced by S04A.

With reference to FIG. 9, in S04A, the controller 100 displays the second structured data, and ends the procedure. In one embodiment, the controller 100 displays the second structured data including the first value and the second value in a tabular format (see FIG. 5) on the display 110, and ends the procedure. In this case, it is preferable that the second value added in S03 is displayed in a specific manner. In other words, the second value is preferably represented in a different manner than the first value. For example, it is preferable that the cell of the second value is surrounded by a bold frame, the cell of the second value is colored, the second value is written in a different font, or the second value is underlined. In this way, the user can easily recognize the second value and compare the second value with a corresponding value in another experiment. As a result, it is possible to confirm whether the second value is appropriately added or not.

As described above, according to the method of processing structured data according to the second modification, it is possible to add a value that is included in the values of all the experimental conditions for conducting a predetermined experiment disclosed in the first information source but cannot be extracted from the first information source without any user operation. In addition, the added experimental conditions can be visually confirmed. Thus, the user can also visually confirm the experimental conditions before conducting the experiment with the automatic experimental apparatus. In one embodiment, the user confirms the values of a row corresponding to a predetermined experiment in the table of FIG. 5, and selects the row to conduct the predetermined experiment with the automatic experimental apparatus.

In addition, the table of FIG. 5 makes it easier for the user to check the experimental conditions. For example, suppose that a user wishes to know an appropriate culture time for culturing E. coli in a flask. For example, the user can determine an appropriate culture time simply by visually confirming the culture time in the row in the table of FIG. 5 where the strain name is “E. coli” and the vessel is “flask”.

When the values of the experimental results are displayed together with the first value and the second value of the experimental conditions, the user can visually confirm the values of the experimental results and select an experiment from which a desired experimental result is expected.

The user can also manually conduct a predetermined experiment with reference to the first value and the second value of the experimental conditions. Also in this case, it is advantageous that the user can save the time and effort in retrieving the first information source by himself/herself and adding the second value. This is particularly useful when the user does not understand the general experimental conditions in the field of the experiment.

### 7. Third Modification

### 7-1. Description of Strain Information Table, Experimental Condition Table, and Experimental Result Table

In the second modification, the first structured data and the second structured data are displayed in one table, but the structured data may include a wide variety of values: the values of strain information and the values of experimental results. In the third modification, the structured data is displayed in three separate tables: a strain information table, an experimental condition table, and an experimental result table, thereby improving convenience.

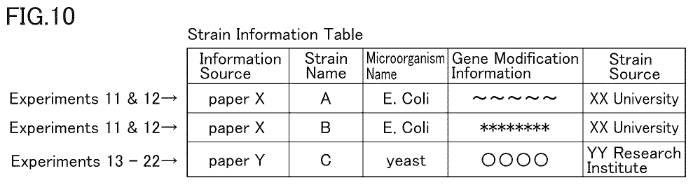

For example, many papers on culture experiments are structured as follows: “what kind of strains were used (strain information)”, “under what conditions the culture was conducted (culture conditions)”, and “what results were obtained (culture results)”. FIGS. 10 to 12 show the values of the strain information, the values of the culture conditions, and the values of the culture results related to an experiment described in a paper on a culture experiment in three independent tables, respectively.

FIG. 10 is a diagram illustrating an example of a strain information table.

The strain information table is a table listing data on strains to be used in experiments. The strain information table includes items of “information source”, “strain name”, “microorganism name”, “gene modification information”, and “strain source”.

The “microorganism name” refers to the name of a microorganism strain. The “microorganism name” includes, as a value, a name such as E. coli or yeast which can be easily understood by those skilled in the art. The “microorganism name” may include a scientific name and/or a taxonomic classification larger than strain as the value.

The “gene modification information” refers to information on gene modification of a strain. For example, when a gene for producing a specific substance is modified, the “gene modification information” includes information such as the name of the specific substance, the name of the modified gene, the modified region in the gene, the gene sequence before and after the modification, and the like as values.

The “strain source” refers to the source of strains. The “strain source” includes, for example, the name of a research agency such as a university, a research institute, or a research laboratory as the value.

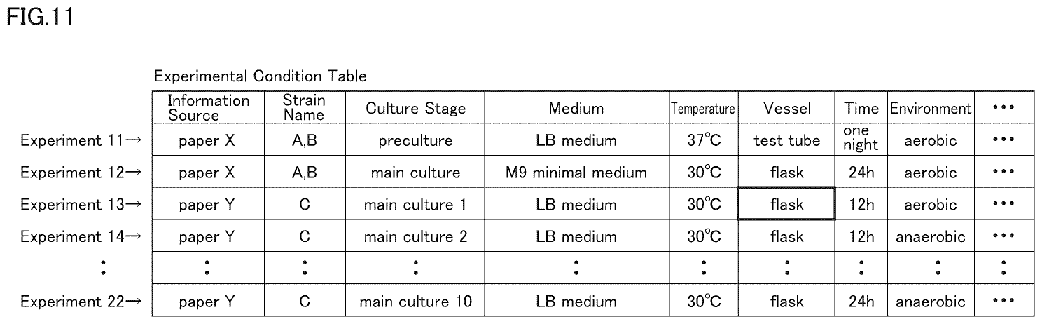

FIG. 11 is a diagram illustrating an example of an experimental condition table. The experimental condition table includes information necessary for culturing a predetermined strain in the same environment as the first information source. Each item in the experimental condition table has been described above.

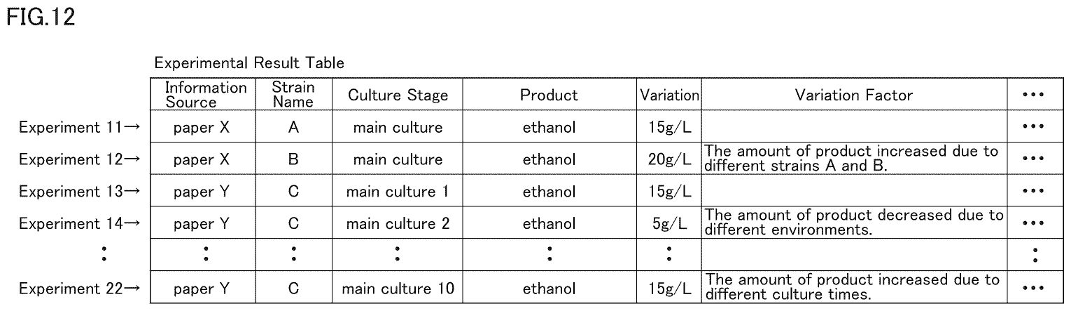

FIG. 12 is a diagram illustrating an example of an experimental result table. The experimental result table includes the results of an experiment conducted for a predetermined strain in a predetermined environment. The experimental result table includes items of “information source”, “strain name”, “culture stage”, “product”, “variation”, and “variation factor”.

The “product” refers to a substance produced by the strain. The “variation” refers to an amount of variation of the product in the medium.

The “variation factor” refers to a factor that causes the product to vary in the medium.

In some papers, the experimental conditions may be finely adjusted so as to compare respective results. For example, in a paper on culture experiments, the culture time and the culture result may be disclosed stepwise such that the amount of product was X g/L when the culture time was 10 hours and the amount of product was Y g/L when the culture time was 20 hours. As described above, when it is disclosed that a small difference in the experimental condition influences the experimental result, an item of “additional culture conditions” may be set for an experiment with a small difference in experimental conditions from other experiments. Thus, the visibility of the experimental condition table can be further improved.

As described above, the strain information table, the experimental condition table, and the experimental result table include a common item of “strain name”. Thus, the strain information, the experimental conditions, and the experimental results are associated to each other for a predetermined strain.

The strain information table, the experimental condition table, and the experimental result table include a common item of “information sources. Thus, the strain information, the experimental conditions, and the experimental results are associated to each other for an experiment of a predetermined strain disclosed in a predetermined information source.

As described above, in the strain information table, the experimental condition table, and the experimental result table, each experiment is defined by “information source” and “strain name”. Therefore, the user can associate data of a predetermined experiment to each other based on the “information source” and the “strain name”.

### 7-2. Flowchart

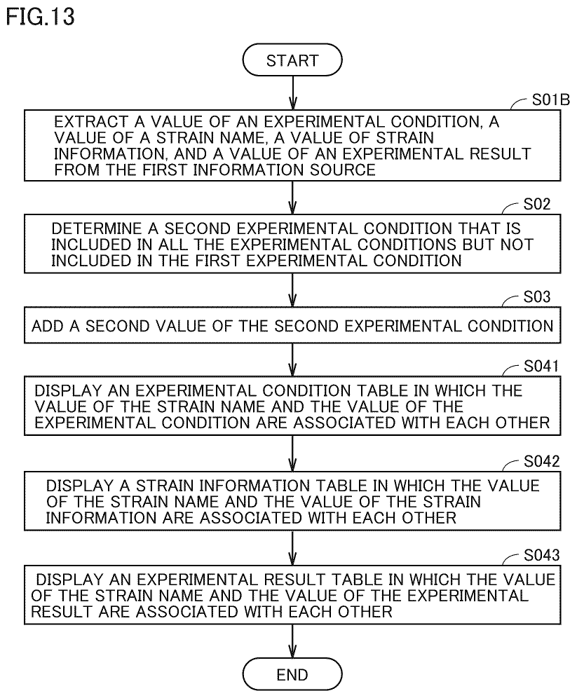

FIG. 13 is a flowchart illustrating a procedure of processing structured data according to a third modification. In the third modification, S01A in the second modification (FIG. 9) is replaced by S01B, and S04A is replaced by S041 to S043.

With reference to FIG. 13, in S01B, the controller 100 extracts a value of an experimental condition, a value of a strain name, a value of strain information, and a value of an experimental result for a predetermined experiment.

In S02, the controller 100 determines a second experimental condition that is included in all the experimental conditions for conducting a predetermined experiment but not included in the first experimental condition.

In S03, the controller 100 adds a second value to the second experimental condition.

In S041, the controller 100 displays an experimental condition table in which the value of the strain name and the value of the experimental condition are associated with each other for each predetermined experiment. In one embodiment, the controller 100 displays an experimental condition table in which the value of the strain name and the value of the experimental condition (the first value and the second value obtained in S01B to S03) are displayed in the same row for a predetermined experiment.

In S042, the controller 100 displays a strain information table in which the value of the strain name and the value of the strain information are associated with each other for each predetermined experiment. In one embodiment, the controller 100 displays a strain information table in which the value of the strain name and the value of the strain information are displayed in the same row for a predetermined experiment.

In S043, the controller 100 displays an experimental result table in which the value of the strain name and the value of the experimental result are associated with each other for each predetermined experiment and ends the procedure. In one embodiment, the controller 100 displays an experimental result table in which the value of the strain name and the value of the experimental result are displayed in the same row for a predetermined experiment.

According to the method of processing structured data of the third modification, in addition to adding the second value to a blank field of the first structured data, the value of the strain information, the value of the experimental condition and the value of the experimental result are displayed in association with the strain name in separate tables for each predetermined experiment. Therefore, in addition to the effect of the first modification, the user can easily obtain the value of the strain information, the value of the experimental condition, and the value of the experimental result for a predetermined strain.

More specifically, displaying the value of the strain information, the value of the experimental condition, and the value of the experimental result in separate tables makes it possible to increase the visibility of each of the value of the strain information, the value of the experimental condition, and the value of the experimental result. Accordingly, the user can easily understand each of the value of the strain information, the value of the experimental condition, and the value of the experimental result.

Specifically, for example, when a user wants to refer to the value of an experimental result, the user does not have to search for the value of the experimental result in the table as compared to the case where the value of the strain information, the value of the experimental condition, which saves the time and effort of the user. In addition, since the amount of information (for example, the number of items and the number of values) included in the table is small, it is easy to understand the value of the experimental result. Therefore, the user can easily select a desired experiment by referring to the value of the experimental result. Similarly, the user can easily select a desired experiment by referring to the value of the strain information or the value of the experimental condition.

As a specific example, with reference to FIGS. 10 to 12, paper Y includes 10 experiments of 13 to 22 in which a plurality of experimental conditions were tested using the same strain C. Thus, each of the experimental condition table and the experimental result table includes 10 lines of information for the experiment on the strain C in paper Y. However, the strain information table only includes one line of information for the experiment on the strain C in paper Y. Thus, when a user tries to check the values corresponding to the strains used in paper Y using the strain information, the user may check only one line of information corresponding to each of the experiments 13 to 22 collectively without checking 10 lines of information corresponding to each of the experiments 13 to 22. Further, when a user refers to the strain information table to check the values corresponding to the strain of the paper X, the user is less likely to see extra information.

As described above, in the third modification, each of the strain information table, the experimental condition table and the experimental result table only lists the minimum necessary items and values in separate tables. This improves the visibility of each table and reduces the amount of data to be displayed on the display 110. Further, if a value is incorrect in each table, it is easy to correct the incorrect value. For example, when it is found that the strain name used in paper Y is actually “strain B”, the user only needs to change the strain name in one corresponding cell in the strain information table, the strain name in the other two linked tables will be automatically changed. As a result, the user does not need to change the strain name for the experiments 13 to 22 for a total number of 10 times.

### 7-3. Conduct Automated Experiment Using Strain Information Table, Experimental Condition Table, or Experimental Result Table

Next, a method of conducting an automatic experiment using each table will be described.

As one embodiment, a user issues an instruction to conduct an automated experiment using a strain information table. For example, the user finds out a row in the strain information table that corresponds to “an experiment on E. coli subjected to a predetermined gene modification” and specifies the row. Then, the controller 100 converts the values of the experimental conditions in a row of the experimental condition table that corresponds to the specified row of the strain information table into a control signal for the experimental apparatus 200.

The user may issue an instruction to conduct an automatic experiment using an experimental condition table. For example, the user finds out a row in the experimental condition table that corresponds to “an experiment of culturing yeast in a flask” and specifies the row. Then, the controller 100 converts the values of the experimental conditions in the specified row into a control signal for the experimental apparatus 200.

The user may issue an instruction to conduct an automatic experiment using an experimental result table. For example, the user finds out a row in the experimental result table that corresponds to “an experiment for increasing an amount of ethanol produced by E. coli” and specifies the row. Then, the controller 100 converts the values of experimental conditions in a row of the experimental condition table that corresponds to the specified row of the experimental result table into a control signal for the experimental apparatus 200.

### 7-4. Association of Strain Information Table, Experimental Condition Table, or Experimental Result Table

As described above, the strain information table, the experimental condition table, and the experimental result table are each associated with information about a predetermined experiment using the “information source” and the “strain name” as keys. Therefore, the user can easily understand the association of the strain information, the experimental conditions, or the experimental results for a predetermined experiment.

For example, the user can easily confirm the value of strain information and/or the value of experimental conditions for a predetermined experiment that yields a favorable result found in the experimental result table. For example, the user may check the strain information table for a predetermined experiment that yields the favorable result found in the experimental result table. Thus, the user can confirm whether the strain used in the predetermined experiment is E. coli or yeast, whether the strain has been genetically modified, what kind of modification has been made if the strain has been genetically modified, where the strain is available, and the like. As a result, the user can easily confirm whether the predetermined experiment can be conducted with the automatic experimental apparatus, whether it is appropriate to conduct the predetermined experiment with the automatic experimental apparatus, whether it is in line with the purpose of the predetermined experiment, or the like.

For example, the user may also check the experimental condition table for a predetermined experiment that yields a favorable result found in the experimental result table. Thus, the user can confirm the experimental conditions under which the favorable result was obtained. As a result, the user can easily confirm whether the predetermined experiment can be conducted with the automatic experimental apparatus, whether it is appropriate to conduct the predetermined experiment with the automatic experimental apparatus, whether it is in line with the purpose of the predetermined experiment, or the like.

As described above, by using a table that independently includes each of the value of the bacterial strain information, the value of the experimental condition, and the value of the experimental result according to the third modification, it is easier to obtain the experimental result, the bacterial strain information, and the experimental condition in a stepwise manner for a predetermined experiment as compared with the case where the value of the bacterial strain information, the value of the experimental condition, and the value of the experimental result are included in one table. Therefore, it can be said that the three tables according to the third modification are useful in presenting the values of the experimental conditions according to the user's desire or adopting the values as the values of the automatic experiment.

The strain information table, the experimental condition table, and the experimental result table may be displayed simultaneously or at different timings.

It is preferable that when a row is specified in any one of the strain information table, the experimental condition table and the experimental result table, the specified row is also displayed in a specific manner in the other two tables. Thereby, it is easier to understand the relationship between the value of the strain information, the value of the experimental condition, and the value of the experimental result for a predetermined experiment.

### Aspects

It will be understood by those skilled in the art that the above-described embodiments and modifications thereof are specific examples of the following aspects.

(First Aspect) A method of processing structured data according to an embodiment of the present invention includes: creating the structured data by using a computer; and generating a control signal for operating an automatic experimental apparatus based on the structured data. The structured data includes a plurality of sets of items and values for conducting a predetermined experiment with the automatic experimental apparatus. The creating the structured data includes: extracting, from a first information source, a first value to be input into the set; and adding a second value to a blank field of the set.

According to the method of processing structured data described in the first aspect, it is possible to add a value that is included in the values of all the experimental conditions for conducting a predetermined experiment disclosed in the first information source but cannot be extracted from the first information source without any operation of a user. Therefore, it is possible to conduct the predetermined experiment disclosed in the first information source. As described above, it is also possible for an automatic analyzer to conduct an experiment in which the values of all the experimental conditions are not disclosed in the first information source such as papers and experimental videos. In other words, it is possible for an automatic experimental apparatus to conduct an experiment using structured data created by extracting experimental condition data from an external source.

(Second Aspect) A method of processing structured data according to another embodiment includes: creating the structured data by using a computer; and displaying the structured data. The structured data includes a plurality of sets of items and values for conducting a predetermined experiment. The creating the structured data includes: extracting, from a first information source, a first value to be input into the set; and adding a second value to a blank field of the set.

According to the method of processing structured data described in the second aspect, it is possible to add a value that is included in the values of all the experimental conditions for conducting a predetermined experiment disclosed in the first information source but cannot be extracted from the first information source without any operation of a user. In addition, the added experimental conditions can be confirmed visually.

(Third Aspect) In the method of processing structured data according to the first or second aspect, the first information source includes papers and/or experiment videos.

Papers and/or experimental videos related to a predetermined experiment often disclose a predetermined experimental result and/or the purpose of a predetermined experiment. Therefore, according to the method of processing structured data described in the third aspect, the user may refer to the experimental result and/or the purpose disclosed in the paper and/or experimental video to decide to conduct the predetermined experiment.

(Fourth Aspect) In the method of processing structured data according to any one of the first to third aspects, the adding the second value includes: determining a second item that is included in all items for conducting the predetermined experiment but not included in a first item corresponding to the first value; selecting a similar experiment of the predetermined experiment from all experiments included in the first information source; and extracting a value of the second item for conducting the similar experiment and setting the second value based on the extracted value.

According to the method of processing structured data described in the fourth aspect, the second value can be added by using the first information source collected for extracting the first value. Thus, it is possible to save the time and effort to collect a new information source for adding the second value.

(Fifth Aspect) In the method of processing structured data according to any one of the first to third aspects, the adding the second value includes: determining a second item that is included in all items for conducting the predetermined experiment but not included in a first item corresponding to the first value; selecting a similar experiment of the predetermined experiment from all experiments included in a second information source; and extracting a value of the second item for conducting the similar experiment and setting the second value based on the extracted value. The second information source includes a textbook.

According to the method of processing structured data described in the fifth aspect, the values of common experimental conditions which are likely to be omitted in a paper and/or an experimental video can be easily added by using a textbook in which the common experimental conditions are disclosed.

(Sixth Aspect) In the method of processing structured data according to any one of the first to fifth aspects, the adding the second value includes: displaying a plurality of candidates for the second value; and receiving a selection of a candidate from the plurality of candidates for the second value to add the second value.

According to the method of processing structured data described in the sixth aspect, the user can select an appropriate value from the plurality of candidates for the second value.

(Seventh Aspect) In the method of processing structured data according to any one of the first to sixth aspects, the first information source includes text data and embed data embedded in the text data. The embed data includes a figure or a table. All items for conducting the predetermined experiment include an item having a priority level higher than a predetermined threshold in the predetermined experiment and an item having a priority level lower than the predetermined threshold in the predetermined experiment. The extracting the first value includes: extracting the first value from the text data; and after extracting the first value from the text data, if a value is deficient in an item having a priority level higher than the predetermined threshold in the predetermined experiment, extracting a deficient value from the embed data.

According to the method of processing structured data described in the seventh aspect, it is possible to prepare values of important experimental conditions in a minimum time.

(Eighth Aspect) In the method of processing structured data according to the second aspect, the extracting the first value includes extracting, from the first information source, a value of an experimental condition, a value of a strain name, a value of strain information, and a value of an experimental result for the predetermined experiment. The displaying the structured data includes: displaying an experimental condition table in which the value of the strain name and the value of the experimental condition are displayed in association with each other for the predetermined experiment; displaying a strain information table in which the value of the strain name and the value of the strain information are displayed in association with each other for the predetermined experiment; and displaying an experimental result table in which the value of the strain name and the value of the experimental result are displayed in association with each other for the predetermined experiment.

According to the method of processing structured data described in the eighth aspect, the user can easily obtain the value of the predetermined strain information, the value of the experimental condition, and the value of the experimental result.

(Ninth Aspect) A computer-readable storage medium that stores a program that, when executed by a computer, causes the computer to perform the method of processing structured data according to any one of the first to eighth aspects.

Although the embodiments of the present invention have been described, the embodiments disclosed herein are illustrative and non-restrictive in all respects. It is intended that the scope of the present invention is not limited to the description above but defined by the scope of the claims and encompasses all modifications equivalent in meaning and scope to the claims.

What is claimed is:

1. A method of processing structured data related to an experiment, the method comprising:
creating the structured data by using a computer; and
generating a control signal for operating an automatic experimental apparatus based on the structured data, wherein
the structured data includes a plurality of sets of items and values for conducting a predetermined experiment with the automatic experimental apparatus,
the creating the structured data includes:
extracting, from a first information source, a first value to be input into the set; and
adding a second value to a blank field of the set.

2. A method of processing structured data related to an experiment, the method comprising:
creating the structured data by using a computer; and
displaying the structured data, wherein
the structured data includes a plurality of sets of items and values for conducting a predetermined experiment,
the creating the structured data includes:
extracting, from a first information source, a first value to be input into the set; and
adding a second value to a blank field of the set.

3. The method of processing structured data according to claim 1, wherein
the first information source includes papers and/or experiment videos.

4. The method of processing structured data according to claim 1, wherein
the adding the second value includes:
determining a second item that is included in all items for conducting the predetermined experiment but not included in a first item corresponding to the first value;
selecting a similar experiment of the predetermined experiment from all experiments included in the first information source; and
extracting a value of the second item for conducting the similar experiment and setting the second value based on the extracted value.

5. The method of processing structured data according to claim 1, wherein
the adding the second value includes:
determining a second item that is included in all items for conducting the predetermined experiment but not included in a first item corresponding to the first value;
selecting a similar experiment of the predetermined experiment from all experiments included in a second information source; and
extracting a value of the second item for conducting the similar experiment and setting the second value based on the extracted value,
the second information source includes a textbook.

6. The method of processing structured data according to claim 1, wherein
the adding the second value includes:
displaying a plurality of candidates for the second value; and
receiving a selection of a candidate from the plurality of candidates for the second value to add the second value.

7. The method of processing structured data according to claim 1, wherein
the first information source includes text data and embed data embedded in the text data,
the embed data includes a figure or a table,
all items for conducting the predetermined experiment include an item having a priority level higher than a predetermined threshold in the predetermined experiment and an item having a priority level lower than the predetermined threshold in the predetermined experiment, and
the extracting the first value includes:
extracting the first value from the text data; and
after extracting the first value from the text data, if a value is deficient in an item having a priority level higher than the predetermined threshold in the predetermined experiment, extracting a deficient value from the embed data.

8. The method of processing structured data according to claim 2, wherein
the extracting the first value includes extracting, from the first information source, a value of an experimental condition, a value of a strain name, a value of strain information, and a value of an experimental result for the predetermined experiment,
the displaying the structured data includes:
displaying an experimental condition table in which the value of the strain name and the value of the experimental condition are displayed in association with each other for the predetermined experiment;
displaying a strain information table in which the value of the strain name and the value of the strain information are displayed in association with each other for the predetermined experiment; and
displaying an experimental result table in which the value of the strain name and the value of the experimental result are displayed in association with each other for the predetermined experiment.

9. A computer readable storage medium that stores a program that, when executed by a computer, causes the computer to perform the method of processing structured data according to claim 1.
